(19) United States
(12) Patent Application Publication
(10) Pub. No.: US 2025/0249463 A1
(43) Pub. Date: Aug. 7, 2025

(54) Material Processing Machine With Removable Screen Cradle Assembly

(71) Applicant: Bandit Industries, Inc., Remus, MI (US)

(72) Inventor: Nicholas Edward Kilpela, Mount Pleasant, MI (US)

(73) Assignee: Bandit Industries, Inc., Remus, MI (US)

(21) Appl. No.: 19/041,565

(22) Filed: Jan. 30, 2025

Related U.S. Application Data
(60) Provisional application No. 63/550,812, filed on Feb. 7, 2024.

(51) Int. Cl. B02C 23/16; B07B 1/46

(52) U.S. Cl. CPC B02C 23/16; B07B 1/46; B02C 2023/165; B07B 2201/04

(57) ABSTRACT

A material processing machine has an infeed system, a discharge system, and a material reducing system mounted between the infeed system and the discharge system. The material processing machine includes a housing, a rotor having a shaft rotatably mounted to the housing, and a drum defining an outer surface. A plurality of processing tool assemblies are coupled to and extending outwardly from the outer surface of the drum. A stop is coupled to the housing. A removable screen cradle assembly partially surrounds the rotor. The screen cradle assembly includes a cradle support structure having first and second ends with the second end seated against the stop when in an assembled state, and at least one screen mounted to the cradle support structure. A retainer is coupled to the housing to engage the first end of the cradle support structure to secure the cradle support structure against the stop.

### CROSS-REFERENCE TO RELATED APPLICATIONS

This application claims priority from U.S. Provisional Application No. 63/550,812, filed on Feb. 7, 2024.

### BACKGROUND

A variety of machines have been developed to chip, cut, grind, or otherwise reduce waste materials such as wood, brush, and green waste. Exemplary material processing machines include chippers (disk and drum types), hammer mills, grinders, whole tree chippers, and the like. The machines typically include an infeed system, a reducing system, and a discharge system. The infeed system directs the material to the reducing system and the material reducing system reduces the same, after which the reduced material is discharged through the discharge system.

Improvements are desired in installing and uninstalling the one or more screens used in the process for reducing the materials.

### SUMMARY OF THE PRESENT DISCLOSURE

The aforementioned drawbacks and disadvantages of these former material processing machines have been identified and solutions are set forth herein.

The subject invention includes a material processing machine having an infeed system, a discharge system, and a material reducing system mounted between the infeed system and the discharge system. The material processing machine comprises a housing, a rotor having a shaft rotatably mounted to the housing, and a drum defining an outer surface. A plurality of processing tool assemblies are coupled to and extending outwardly from the outer surface of the drum. A stop is coupled to the housing. A removable screen cradle assembly is partially surrounding the rotor. The screen cradle assembly comprises a cradle support structure having first and second ends with the second end seated against the stop when in an assembled state, and at least one screen mounted to the cradle support structure. A retainer is coupled to the housing to engage the first end of the cradle support structure to secure the cradle support structure against the stop.

The subject invention also includes the removable screen cradle assembly for use in the reducing chamber of the material processing machine where the removable screen cradle assembly partially surrounds the rotor and comprises the cradle support structure having first and second ends with the second end configured to be seated against the stop when the material processing machine is in an assembled state, and the at least one screen mounted to the cradle support structure.

The subject invention further includes a method of installing at least one screen into a material processing machine, with the material processing machine including a housing, a rotor having a shaft mounted to the housing and a drum defining an outer surface, a plurality of processing tool assemblies coupled to and extending outwardly from the outer surface of the drum, a stop coupled to the housing, a retainer coupled to the housing, and a screen cradle assembly having a cradle support structure. The method comprising the steps of: mounting the at least one screen to the cradle support structure of the screen cradle assembly; introducing the screen cradle assembly within the housing; rotating the screen cradle assembly about the rotor until a second end of the cradle support structure seats against the stop; and engaging the retainer to the first end of the cradle support structure to secure the cradle support structure against the stop.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a perspective view of a material processing machine.

FIG. 2 is a perspective view of a portion of a material processing machine in accordance with the subject invention.

FIG. 3 is another perspective view of the portion of the material processing machine of FIG. 2.

FIG. 4 is a cross-sectional perspective view of the portion of the material processing machine of FIG. 2.

FIG. 5 is a cross-sectional side view of the portion of the material processing machine of FIG. 2.

FIG. 6 is a cross-sectional perspective view of the portion of the material processing machine with a screen cradle assembly being removed.

FIG. 7 is a cross-sectional side view of the portion of the material processing machine with a rotor and drum being removed.

FIG. 8 is perspective view of the portion of the material processing machine of FIG. 3 with a cover in an open position.

FIG. 9 is perspective view of the portion of the material processing machine of FIG. 2 with the cover in an open position.

FIG. 10 is a cross-sectional perspective view of the portion of the material processing machine with the cover in an open position.

FIG. 11 is a front perspective view of the screen cradle assembly.

FIG. 12 is a rear perspective view of the screen cradle assembly.

FIG. 13 is an exploded perspective view of the screen cradle assembly.

FIG. 14 is another exploded perspective view of the screen cradle assembly.

FIG. 15 is a cross-sectional side view of the portion of the material processing machine with the cover in the open position and the screen cradle assembly in an initial installation position.

FIG. 16 is a cross-sectional side view of the portion of the material processing machine with the cover in the open position and the screen cradle assembly in an intermediate installation position.

FIG. 17 is a cross-sectional side view of the portion of the material processing machine with the cover in the open position and the screen cradle assembly in another intermediate installation position.

FIG. 18 is a cross-sectional side view of the portion of the material processing machine with the cover in the open position and the screen cradle assembly in a final installation position.

### DETAILED DESCRIPTION

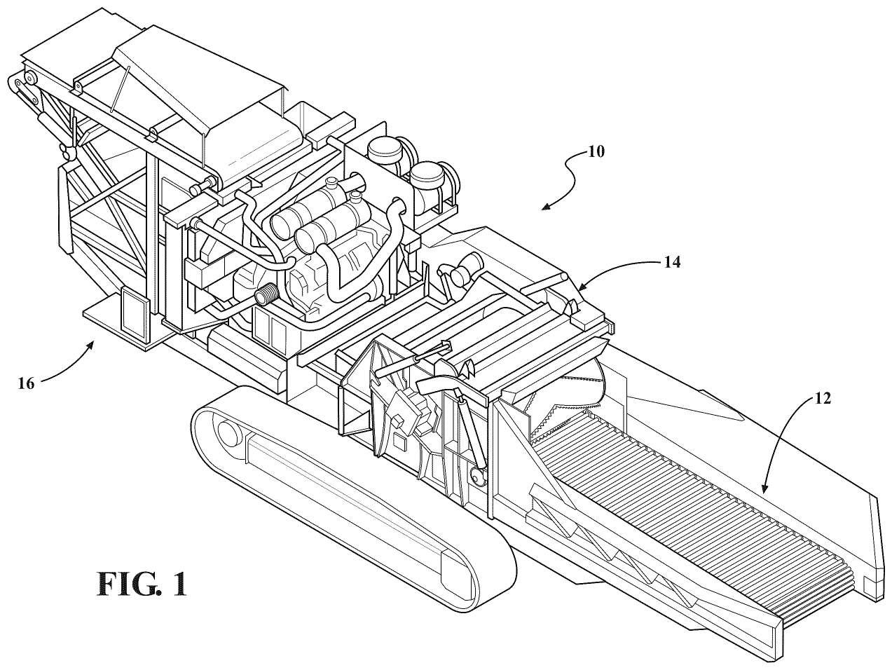

Referring to the Figures, wherein like numerals indicate like or corresponding parts throughout the several views, FIG. 1 illustrates an exemplary material processing machine 10 (sometimes alternatively referred to herein as a processing machine 10 or a waste processing machine 10) having an infeed system 12, a material reducing system 14 operatively coupled to the infeed system 12, and a discharge system 16 operatively coupled to the reducing system 14. The infeed system 12 and discharge system 16 can be of any suitable design or configuration and that shown in FIG. 1 is one example. The material reducing system 14 can likewise be of varying configurations with one such example shown in greater detail below.

During operation, material, such as waste material, enters the material processing machine 10 through the infeed system 12 where it is directed to the reducing system 14. The reducing system 14 reduces the material after which the discharge system 16 expels the material from the material processing machine 10. The infeed system 12 often includes one or more feed wheels rotatably mounted to a suitable structure. The feed wheels are configured to move the waste material to the reducing system 14. Subsequent to material reduction, the material is directed to the discharge system 16 and discharged from the material processing machine 10. The discharge system 16 may comprise a discharge conveyor.

The material processing machine 10 shown in FIG. 1 is also known as a horizontal grinder or hammer mill, and is supported on a frame. The frame can have opposing tracks for propelling the machine 10. Alternatively, these systems can be installed on a trailer frame having a tongue mount and wheels.

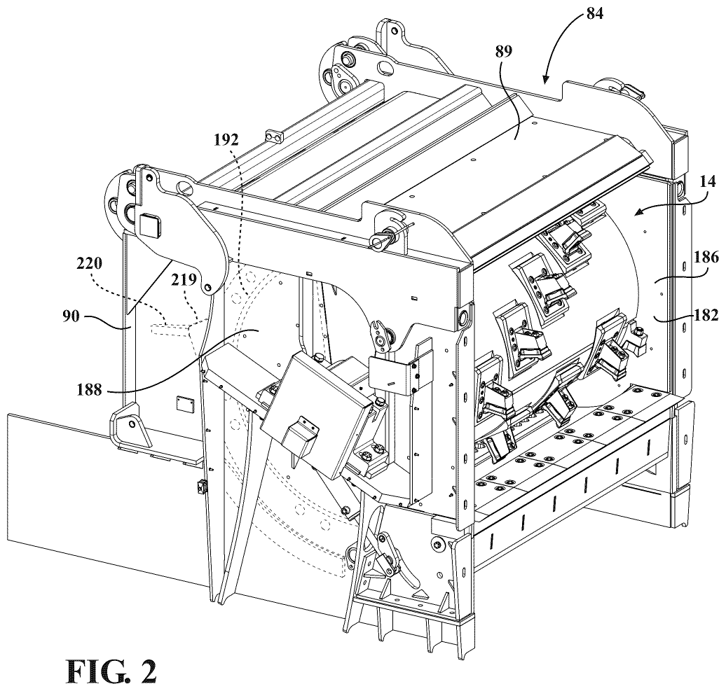

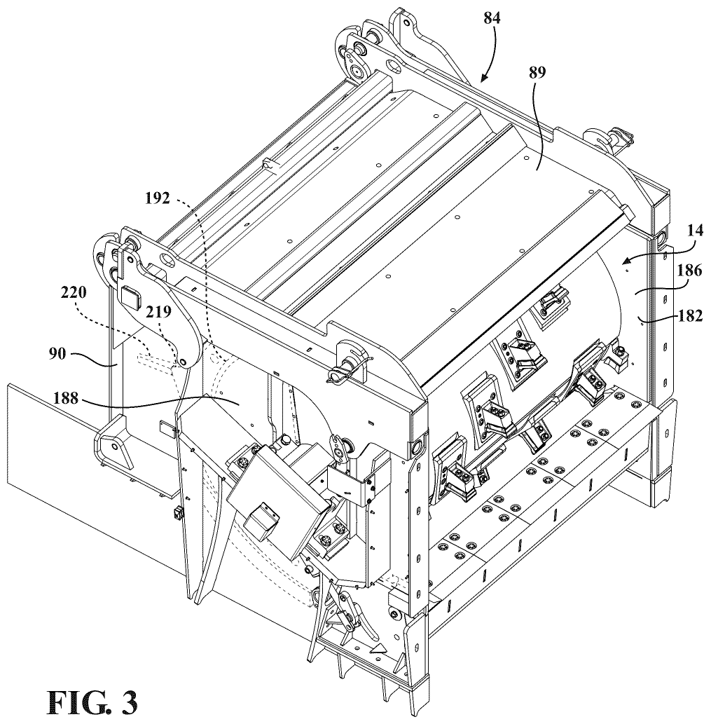

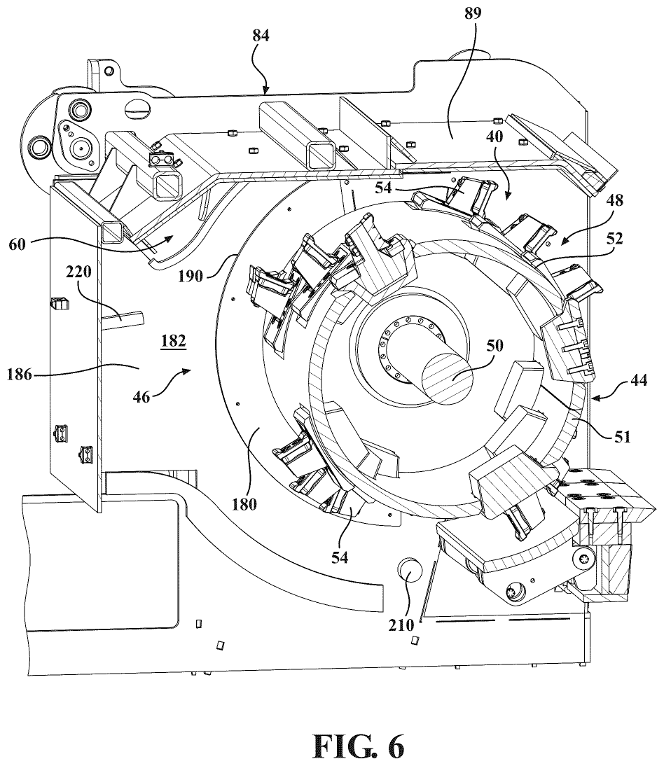

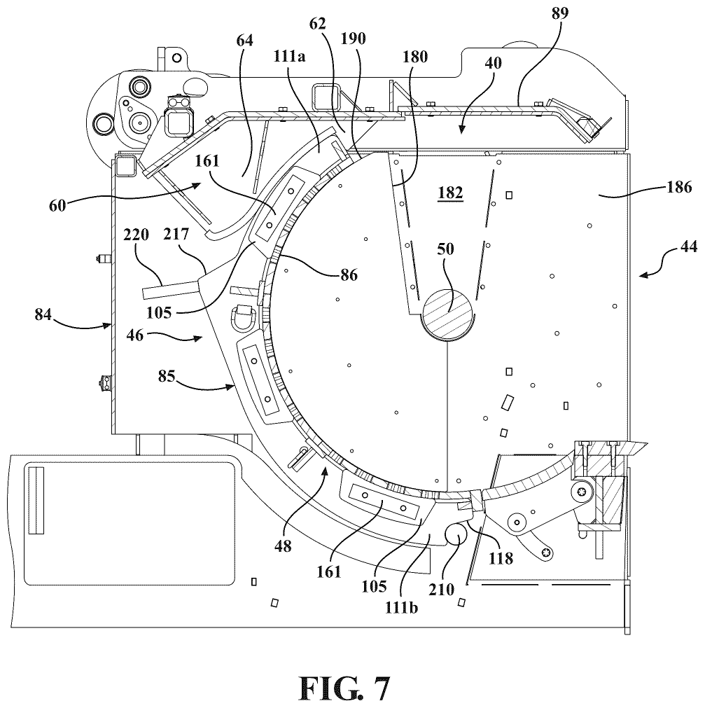

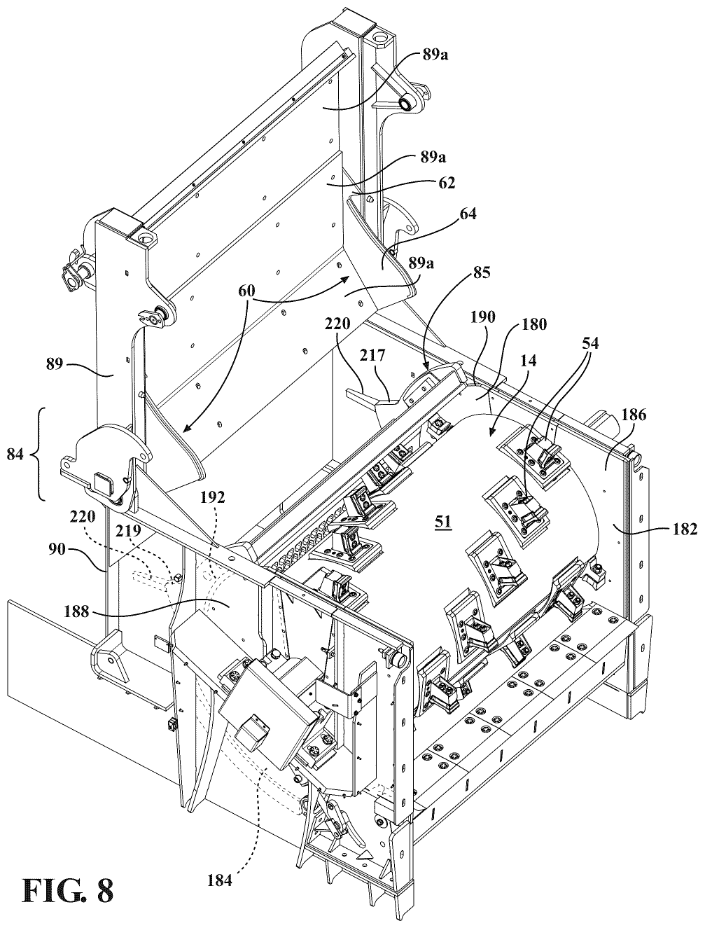

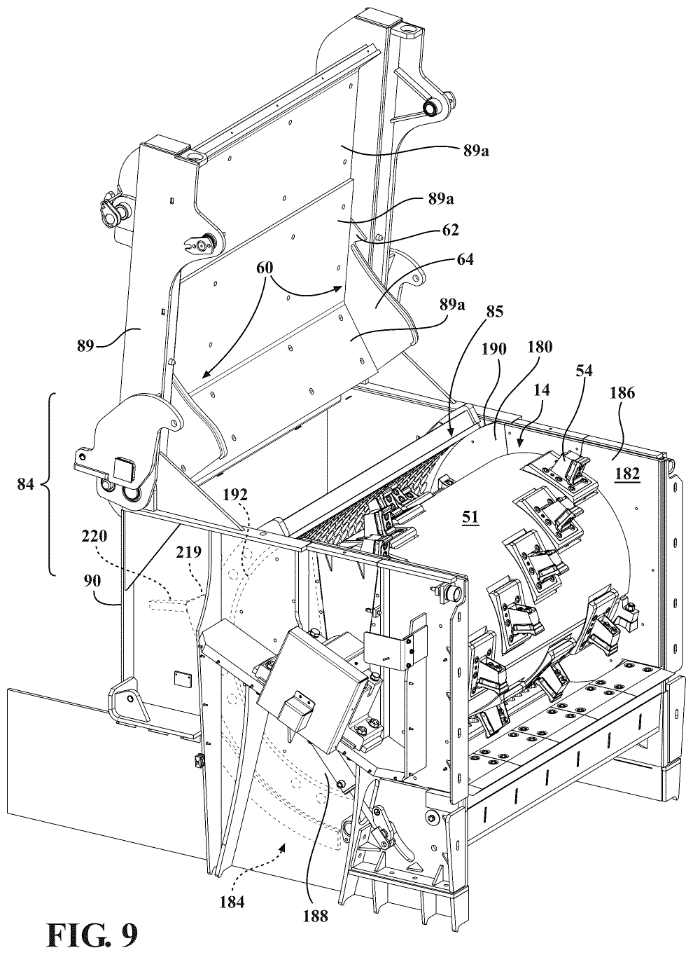

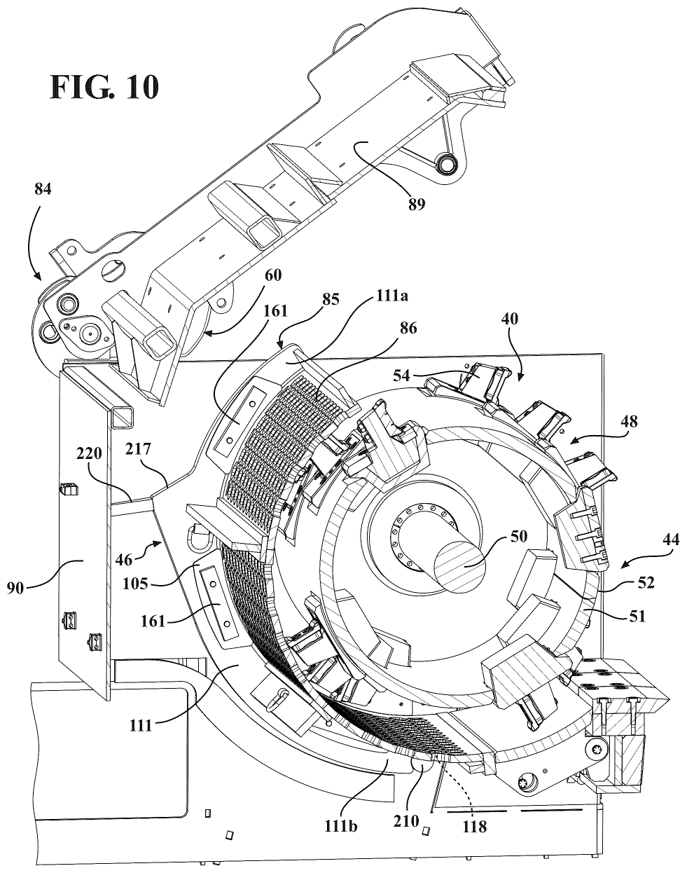

Referring to FIGS. 2-10, a portion of the material processing machine 10 is shown in greater detail. This portion includes the material reducing system 14. The material reducing system 14 comprises a reducing chamber 40 generally defined as an area of the material processing machine 10 within which material is reduced. The material reducing system 14 comprises a housing 84 and a rotor 48 having a shaft 50 rotatably mounted to the housing 84 and a drum 51 defining an outer surface 52. In the embodiment shown, the shaft 50 is mounted at its ends about longitudinal axis L. The reducing chamber 40 comprises an inlet area 44 and an outlet area 46. In one embodiment, the reducing chamber 40 is a partially cylindrical. The inlet area 44 is generally defined as the area or opening through which the waste material enters the reducing chamber 40 from the infeed system 12.

The rotor 48 and drum 51 defining the outer surface 52 is coaxially disposed with the shaft 50. An exemplary drum 51 may comprise a diameter of forty-eight inches and a width of sixty-three inches. For material processing machines 10 with more demanding operating conditions, the drum 51 may comprise a larger diameter and be of a greater or lesser width. A motor is connected to the shaft 50 in a well-known manner and adapted to turn the shaft 50 and the rotor 48 in an operating direction OD, or the direction in which the rotor 48 and shaft 50 rotates.

The rotor 48 has a plurality of processing tool assemblies 54 extending outwardly from the outer surface 52 of the drum 51. The material reducing system 14 may comprise forty-two, fifty-four, sixty, seventy-two, or any number of processing tool assemblies 54. The present disclosure contemplates that the processing tool assemblies 54 may be arranged on the outer surface 52 in any number of desired configurations. For example, the processing tool assemblies 54 may be arranged in a generally spiral configuration between the opposing ends of the drum 51. Among other advantages, the spiral configuration may similarly optimize coverage of the processing tool assemblies 54 about the drum 51 to limit abrasion of the material on the drum 51 and promote a smoother, shaving-style cutting operation. Further, the spiral configuration may urge the reduced material towards a center (i.e., generally intermediate the opposing ends) of the drum 51 to concentrate the processed material. Directing the reduced material towards the center may improve operations such as mulching and prevent debris from encroaching on bearings of the shaft 50. The processing tool assemblies 54 may be arranged in any advantageous manner based on the application or otherwise.

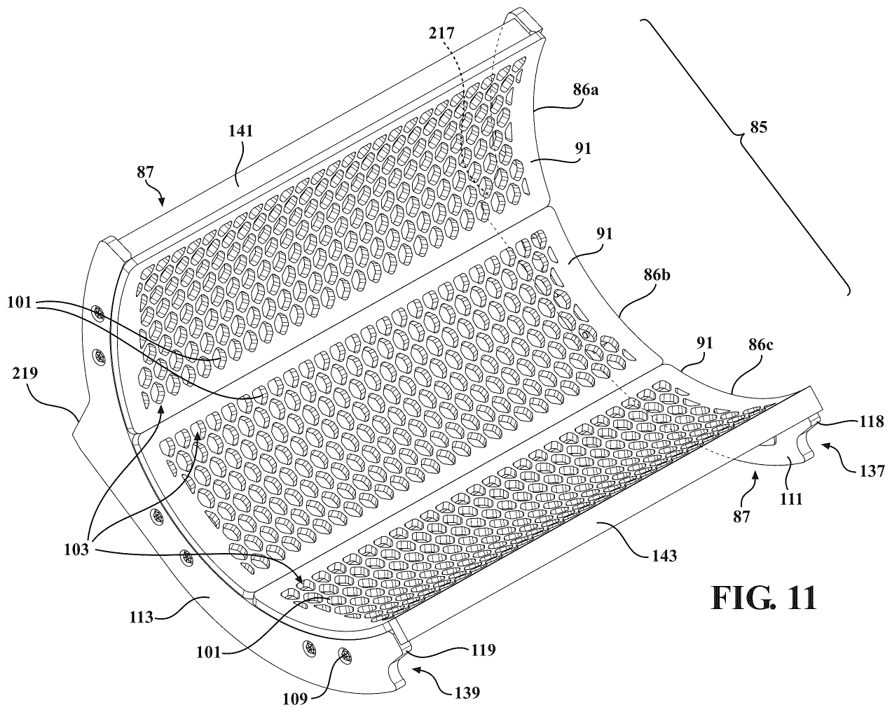

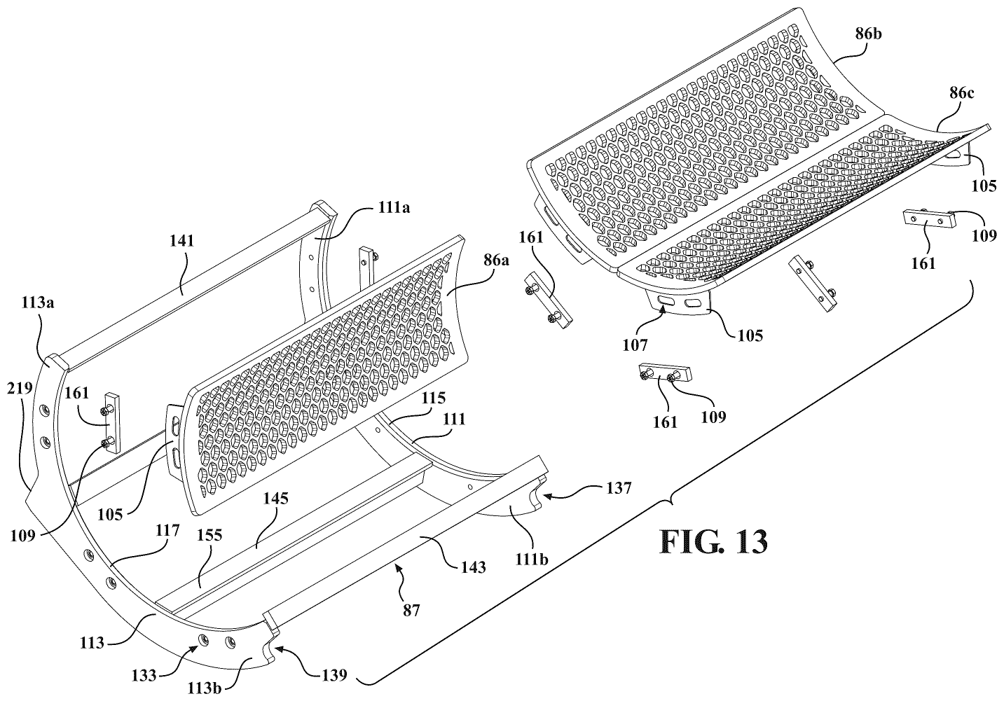

The material reducing system 14 also includes a removable screen cradle assembly 85 partially surrounding the rotor 48. The screen cradle assembly 85 includes one or more screens 86 disposed on a cradle support structure 87 (the screens 86 and cradle support structure 87 of the screen cradle assembly 85 are separately shown in FIGS. 11-14) that at least partially encircle the rotor 48 and define a boundary of the reducing chamber 40. The cradle support structure 87 has first 111a, 113a and second 111b, 113b ends.

The material reducing system 14 also includes a stop 210 coupled to the housing 84. The stop 210 may be of any suitable design or configuration, and as discussed in greater detail below, the stop 210 is shown in the Figures as a pin, and is discussed in greater detail below. The second end 111b, 113b of the cradle support structure 87 is seated against the stop 210 when in an assembled state.

The housing 84 may include barriers 89, 90. One barrier 89 is the cover 89 (also referred to alternatively as a base hood 89). The other barrier 90 (also referred to as a rear barrier 90) is a back wall. As mentioned, the cover 89 is pivotally attached to the housing 84, and can be pivotally attached the rear barrier 90. The cover 89 moves or pivots between an opened position to allow access to the reducing chamber 40 between operations and a closed position during operation of the material processing machine 10.

As discussed in greater detail below, a retainer 60 is coupled to the housing 84 to engage the cradle support structure 87. In the preferred embodiment, the retainer 60 engages the first end 111a, 113a of the cradle support structure 87 to secure the cradle support structure 87 against the stop 210. As shown, the retainer 60 is mounted to an inner surface of the cover 89. In the preferred embodiment, there are two retainers 60 spaced from each other, but it should be appreciated there may be any number of retainers 60 as needed. The retainer 60 preferably includes at least one hooked portion 62 that is configured to hook around and retain the screen cradle assembly 85 when the screen cradle assembly 85 is installed within the reducing chamber 40 and the cover 89 is pivoted to the closed position, as will be described further below. Preferably, the hooked portion 62 engages the first end 111a, 113a of the cradle support structure 87 to secure the cradle support structure 87 against the stop 210. The retainer 60 preferably also includes a brace portion 64 adjacent the hooked portion 62 with the brace portion 64 engaging a part of the screen cradle assembly 85. As shown, each of the hooked 62 and brace 64 portions are integrated into a unitary retainer 60 having a plate-like structure. It is to be appreciated that the hooked 62 and brace 64 portions may be separated from each other such that each retainer 60 could be formed of multiple components.

The screen cradle assembly 85 with the screen(s) 86 may be arcuate with a radius of curvature approximate the rotor 48 such that at least a portion of the reducing chamber 40 is substantially coaxial to the rotor 48 when viewed in elevation. In certain embodiments, the feed wheel assembly noted above is mounted to the base hood 89.

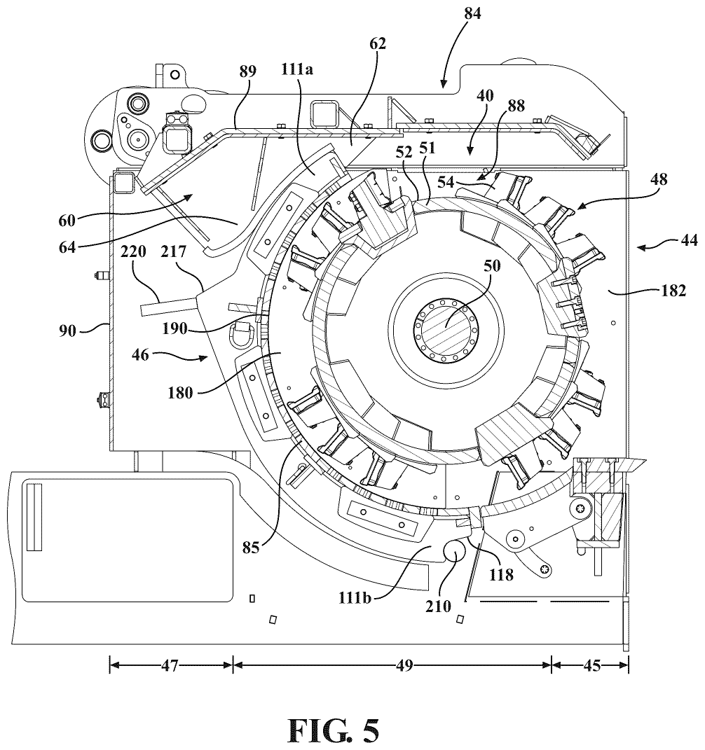

The housing 84 may define other characteristics of the reducing chamber 40, such as side barriers. For another example, the cover 89 and rear barrier 90 of the housing 84 generally define an upper recess 88 within the reducing chamber 40 (see FIG. 5). The upper recess 88 may be positioned intermediate the inlet area 44 and the outlet area 46, and more particularly within a transition zone 49 and/or an outlet zone 47 and a portion of an inlet zone 45. The upper recess 88 is configured to provide an area of clearance between the processing tool assemblies 54 and the boundary of the reducing chamber 40 to minimize a throttling effect at the boundary and reduce wear from any material and/or non-reducible objects (e.g., a rock or other hard debris) moving about the boundary in the operating direction OD by limiting the contact between the same. The upper recess 88 also provides an area of clearance for non-reducible objects to be temporarily deposited before being directed in the operating direction OD to the inlet zone 45. Due to potential wear proximate the upper recess 88, one or more of the cover 89 and rear barrier 90 may be removably secured to provide ease of replacement. For example, the cover 89 may define a “roof” comprising one or more slats 89a configured to be slidably removed and installed. The slats 89a may be supported at its ends or secured with fasteners as commonly known in the art.

The boundary of the reducing chamber 40 is at least partially comprised of the screen cradle assembly 85 having one or more screens 86 disposed on the cradle support structure 87. The screen cradle assembly 85 is generally positioned within the transition zone 49 and separate the reducing chamber 40 from the discharge system 16. The screen cradle assembly 85 is configured to be secured into place during operation of the material processing machine 10 without the use of fasteners but is easily removable and replaceable between operations. The one or more screens 86, and more preferably a plurality of screens 86, of the screen cradle assembly 85 are positioned adjacent to each other along the cradle support structure 87 and each may be arcuate and substantially concentric with the rotor 48, corresponding to the arcuate shape of the screen cradle assembly 85, during operation of the material processing machine 10.

Preferably, a plurality of screens 86 are utilized, and each of the screens 86 are respectively disposed on the cradle support structure 87 and are separated from the processing tool assemblies 54 by a gap. The gap is preferably small such that the potential for the screens 86 to facilitate further reduction of the material is insignificant. Stated differently, an insignificant amount of material is further reduced by edges of the openings (i.e., the apertures 101 defining openings 103) of the screens 86. Rather, the screens 86 permit the waste material to exit the reducing chamber 40 once sufficiently reduced.

The screen cradle assembly 85, the screen(s) 86, and the cradle support structure 87, and their installation within the material processing machine 10, will be discussed further below.

Referring now to FIGS. 11-14, one embodiment of the screen cradle assembly 85 is illustrated as having a plurality of screens 86 disposed upon and secured to the cradle support structure 87. As shown, there are three screens 86 including a first end screen 86a, an intermediate screen 86b, and a second end screen 86c. In further alternative embodiments, the number of intermediate screens 86b between the first 86a and second end screens 86c may be one or more intermediate screens 86b, such as two or more intermediate screens 86b.

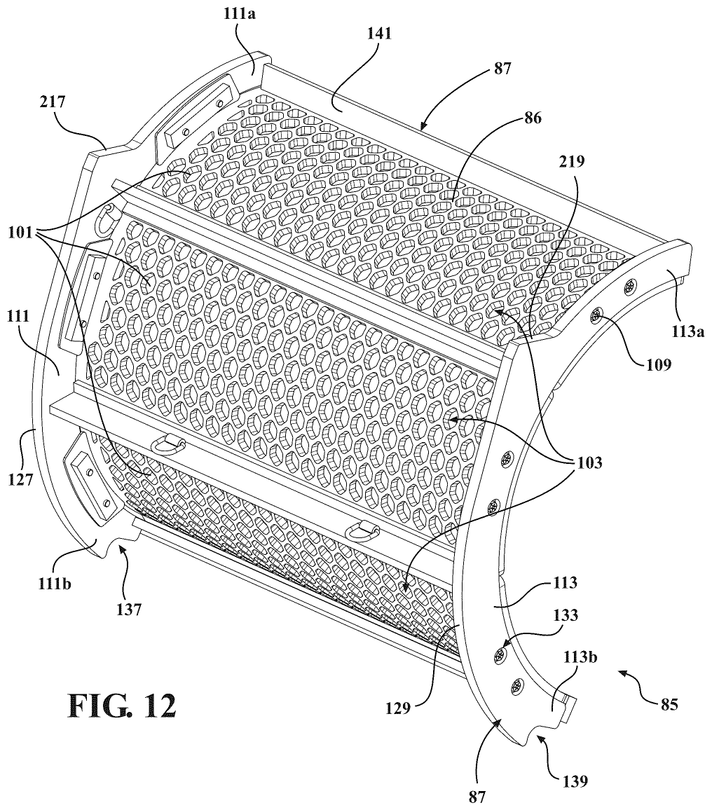

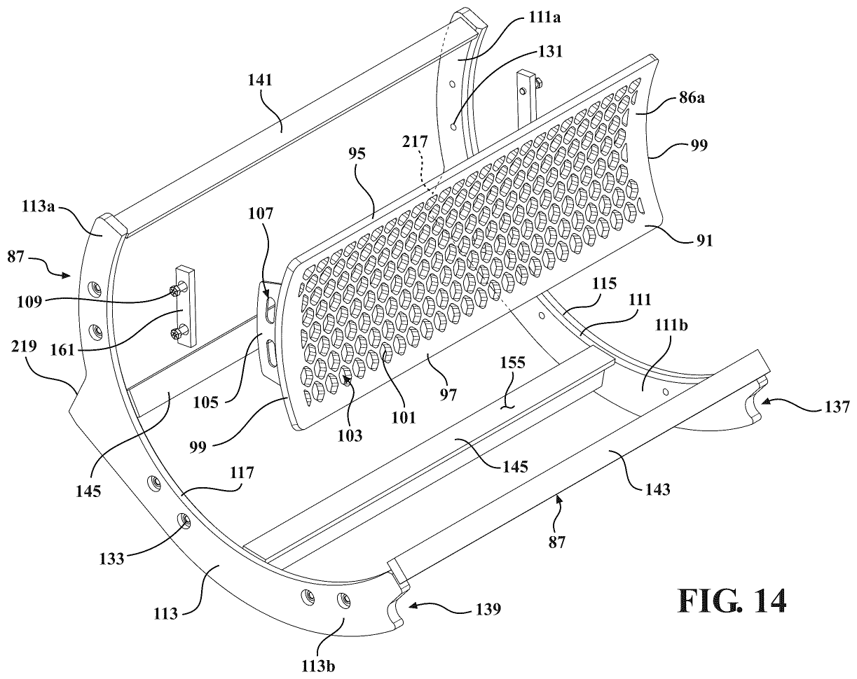

As perhaps best shown in FIGS. 12 and 14, the screens 86, 86a, 86b, 86c may be arcuate with a radius of curvature approximate the rotor 48 such that at least a portion of the reducing chamber 40 is substantially coaxial to the rotor 48. In particular, the screens 86, 86a, 86b, 86c may include an arcuate front face 91 and an opposing arcuate rear face 93 defined as extending between a top edge 95 and a bottom edge 97. The arcuate front face 91 is also defined as extending between opposing respective widthwise side edges 99 to form a generally rectangular shape with a width defined between the opposing respective widthwise side edges 99 generally spanning the width of the reducing chamber 40. Preferably, the perimeter dimensions of each of the screens 86, 86a, 86b, 86c, (i.e., the length of each of top edge 95 and the bottom edge 97 is the same, as is the length of each of the opposing respective widthwise side edges 99), so that each of the screens 86, 86a, 86b, 86c is rectangular in shape along the perimeter and is interchangeable with any other screen 86, 86a, 86b, 86c.

One embodiment of each of the screens 86, 86a, 86b, 86c includes a plurality of apertures 101 extending through the respective arcuate front 91 and rear faces 93. The plurality of apertures 101 is also defined as comprising a plurality of openings 103 arranged in any suitable manner and of any suitable size. In the illustrated embodiment, the openings 103 are arranged in offset rows with each of the openings 103 being circular in shape. Other contemplated shapes for the openings 103 include squares, hexagons, diamonds, and baffles. The plurality of openings 103 are configured on the screens 86, 86a, 86b, 86c such that the rotation of the rotor 48 in an operating direction provides for substantially an entirety of the waste material reduced within the inlet zone 45 and transition zone 49 to pass through the screen 86 to the discharge system 16.

Each of the screens 86, 86a, 86b, 86c also includes a pair of brackets 105 extending away from the arcuate rear face 93 adjacent to a respective one of widthwise side edges 99 that are used to secure the respective screen 86, 86a, 86b, 86c to the cradle support structure 87. It is to be understood that any suitable bracketry may be included on the screen 86, 86a, 86b, 86c to effectuate mounting the screen 86, 86a, 86b, 86c to the cradle support structure 87. As illustrated, the brackets 105 each define one or more openings 107 configured to receive a fastener 109 therethrough to secure the respective brackets 105 to the cradle support structure 87, as will be described further below.

The cradle support structure 87 includes a pair of spaced apart arcuate side members 111, 113 (also referred to as cradle arms 111, 113) each extending between the first end 111a, 113a and the second end 111b, 113b of the cradle support structure 87. The arcuate side members 111, 113 each include an arcuate shaped inner surface 115, 117 extending transverse to and between a respective inward side surface and an outward side surface 127, 129. The arcuate side members 111, 113 each define openings 131, 133 extending between the corresponding respective inward side surface and outward side surface 127, 129 that is sized to accept a fastener 109 therethrough.

As perhaps best shown in FIG. 11, a lower surface 118, 119 at the second end 111b, 113b of each of the pair of spaced apart arcuate side members or cradle arms 111, 113 is shaped to be seated against the stop 210 or stops 210 when in the assembled state. In the embodiment shown, the stop 210 is in the form of a pin 210 or a respective one of a pair of pins 210 attached to and extending from one, or both, of opposing vertically extending sides 186, 188 of the housing 84. It should be appreciated that the stop 210 may be of any suitable shape or configuration. In certain embodiments, the lower surface 118 at the second end 111b of one of spaced apart arcuate side members or cradle arms 111 defines a notch 137 that is seated on the stop or pin 210 or one of the pair of stops or pins 210 (if utilized) in the assembled state. The lower surface 119 at the second end 113b of the other one of spaced apart arcuate side members or cradle arms 113 also defines a notch 139 that is seated on the stop or pin 210 and spaced from the notch 137 or on the other one of the pair of stops or pins 210 (if two pins 210 are utilized) in the assembled state.

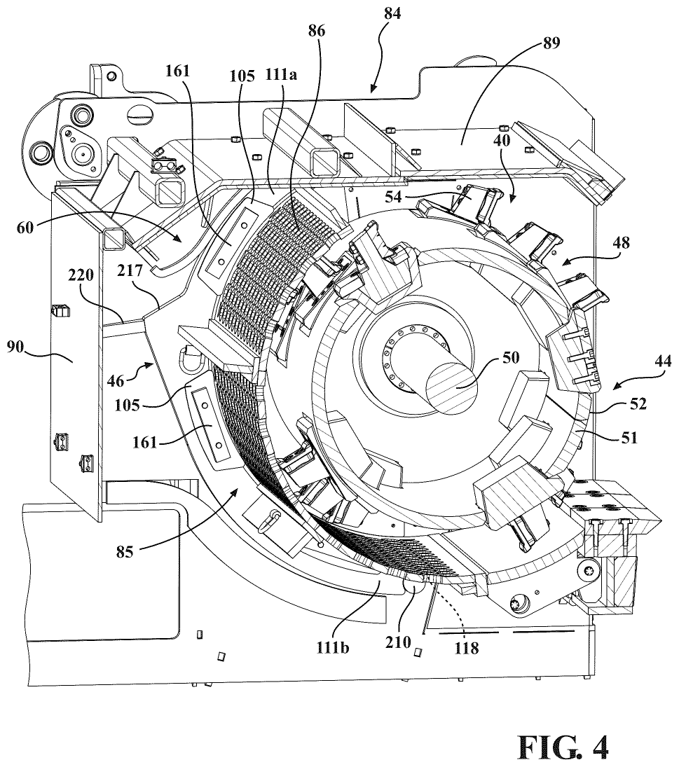

The retainer 60 having the hooked portion 62 and engaging the first end 111a, 113a of the cradle support structure 87, secures the cradle support structure 87 against the stop 210. As mentioned, the cradle support structure 87 also includes arcuate cradle arms 111, 113. The retainer 60 further includes the brace portion 64 adjacent the hooked portion 62 with the brace portion 64 engaging the cradle arms 111, 113. This is perhaps best shown in FIGS. 4, 5, and 7. Preferably, the brace portion 64 has a complementary configuration to the engaged part of the cradle arms 111, 113 to provide adequate force and pressure against the cradle support structure 87 to assist in holding the screen cradle assembly 85 in position during operation. It should be appreciated that the brace portion 64 may be of any suitable shape or length, and could engage other portions of the screen cradle assembly 85 as desired.

The material processing machine 10 further includes a first guide 180 mounted to the housing 84 and a second guide 220 mounted to the housing 84 spaced from the first guide 180. The first guide 180 is secured to the housing 84 with the cradle support structure 87 abutting the first guide 180 and moving along the first guide 180 when installed within or removed from the housing 84. Similarly, the second guide 220 is secured to the housing 84 where the cradle support structure 87 includes an outward projection 217, 219 with the outward projection 217, 219 engaging the second guide 220 when the cradle support structure 87 is in the assembled state. As discussed in greater detail below, the first guide 180 can be in the form of a wear plate, and the second guide 220 can be in form of a plate welded to or integrated into the side of the housing 84. Due to the unique features of the invention, the screen cradle assembly 85 can be exclusively held into position by the stop 210, the retainer 60, the first guide 180, and the second guide 220. In other words, no fasteners are required to hold the screen cradle assembly 85 in position during operation. This greatly improves the efficiency of the operation and allows for efficient servicing. As appreciated, the retainer 60 applies a first force against the first end 111a, 113a of the cradle support structure 87 and the stop 210 applies a second reactive force against the second end 111b, 113b of the cradle support structure 87 to radially fix the screen cradle assembly 85 within the housing 84. As mentioned, the retainer 60 can include the hooked 62 and brace 64 portions and the stop 210 can be in the form of a pin.

The cradle support structure 87 comprises arcuate cradle arms 111, 113 connected together by support beams 141, 143, 145 with one of the cradle arms 111, 113 and the support beams 141, 143, 145 further defining the first end 111a, 113a and the second end 111b, 113b. The notch 137, 139 is formed in this second end 111b, 113b. Meaning, the notch 137, 139 is formed in either the cradle arms 111, 113 or the support beams 141, 143, 145 at the second end 111b, 113b. The notch 137, 139 is seated against the stop 210. The cradle support structure 87 includes spaced apart arcuate cradle arms 111, 113 and wherein each one of the at least one screen 86 includes a pair of spaced apart brackets 105 with the brackets 105 abutting corresponding cradle arms 111, 113 to facilitate mounting of the screen 86 (or screens 86) to the cradle support structure 87. As mentioned, in the preferred embodiment, the at least one screen 86 comprises a plurality of screens 86 each mounted to the cradle support structure 87.

As eluded to above, the outward side surface 127, 129 of each of the respective arcuate side members or cradle arms 111, 113 includes an outward projection 217, 219, which is spaced between the first end 111a, 113a and the second end 111b, 113b. The outward projection 217, 219 assists an operator in rotating the cradle support structure 87 such that the lower surface 118 of the second end 111b, 113b of the respective arcuate side members or cradle arms 111, 113 is seated onto the respective stop 210 during assembly. In particular, as the screen cradle assembly 85 is inserted and rotated towards the stop 210, the outward projections 217, 219 are brought into contact with the respective second guide 220, which are integrally formed or otherwise affixed to one or both of the opposing vertically extending sides 186, 188 of the housing 84 The contact between the outward projections 217, 219 and the second guide 220 assists in maintaining the cradle assembly 85 in proper rotational alignment so that the notches 137, 139 are aligned with the stop 210 and properly seated onto the stop 210.

The respective first end 111a, 113a of each of the pair of spaced apart arcuate side members or cradle arms 111, 113 are connected together with a first end support beam 141, while the respective second end 111b, 113b of each of the pair of spaced apart arcuate side members or cradle arms 111, 113 are connected together with a second end support beam 143. In addition, one or more intermediate support beams 145 may be included to connect together the pair of spaced apart arcuate side members or cradle arms 111, 113 between the respective first ends 111a, 113a and second ends 111b, 113b of the pair of spaced apart arcuate side members 111, 113.

In certain embodiments, each of the support beams 141, 143, 145 include a top surface configured to extend generally planar from the corresponding portions of the respective arcuate shaped inner surface 115, 117. Opposing ends of each of the support beams 141, 143, 145 are positioned adjacent to the corresponding respective inward side surfaces of the arcuate side members 111, 113.

The screen cradle assembly 85 also includes a plurality of blocks 161 that are used in securing the brackets 105 of the respective screen 86, 86a, 86b, 86c to the corresponding respective inward side surface of the arcuate side members 111, 113. The blocks 161 include openings that are aligned with the openings 131, 133 in the arcuate side members 111, 113 and the openings 107 in the brackets 105 and through which a fastener 109 is received to secure the brackets 105 and block 161 to a respective the arcuate side members 111, 113 in the assembled state.

Accordingly, to assemble the screen cradle assembly 85 in the fully assembled state, the second end screen 86c is positioned onto the cradle support structure 87 with the bottom edge 97 aligned and positioned along the length of the top surface of second end support beam 143. In addition, the top edge 95 is aligned and positioned onto the top surface of the closest intermediate support beam 145. Still further, each of the respective widthwise side edges 99 are positioned along the respective arcuate shaped inner surface 115, 117 at the respective second end 111b, 113b. Also, the spaced apart brackets 105 of the second end screen 86c are disposed adjacent to the corresponding respective inward side surface with the openings 107 of the brackets 105 aligned with the openings 131, 133 of a respective one of the arcuate side members 111, 113. A block 161 is positioned such that its opening is aligned with the respective pair of aligned openings and a fastener 109 is inserted through the aligned openings to secure one of the brackets 105 and one of the blocks 161 to secure the second end screen 86c to the arcuate side member 111. Similarly, another block 161 is positioned such that its opening is aligned with the respective pair of aligned openings and a fastener 109 is inserted through the aligned openings to secure the other one of the brackets 105 and another one of the blocks 161 to secure the second end screen 86c to the arcuate side member 113.

The process continues wherein an intermediate screen 86b is positioned onto the cradle support structure 87 with the bottom edge 97 aligned and positioned along the length of the top surface of the intermediate support beam 145 with the bottom edge 97 of the intermediate screen 86b abutting with the top edge 95 of the second end screen 86c. In addition, the top edge 95 is aligned and positioned onto the top surface of the next closest intermediate support beam 145. Still further, each of the respective widthwise side edges 99 are positioned along the respective arcuate shaped inner surface 115, 117 and spaced from each of the respective first ends 111a, 113a and the second ends 111b, 113b of the pair of spaced apart arcuate side members or cradle arms 111, 113. Also, the spaced apart brackets 105 of the intermediate screen 86b are disposed adjacent to the corresponding respective inward side surface with the openings 107 of the brackets 105 aligned with the openings 131, 133 of a respective one of the arcuate side members 111, 113. A block 161 is positioned such that its opening is aligned with the respective pair of aligned openings and a fastener 109 is inserted through the aligned openings to secure one of the brackets 105 and one of the blocks 161 to secure the intermediate screen 86b to the arcuate side member 111. Similarly, another block 161 is positioned such that its opening is aligned with the respective pair of aligned openings and a fastener 109 is inserted through the aligned openings to secure the other one of the brackets 105 and another one of the blocks 161 to secure the intermediate screen 86b to the arcuate side member 113. This process is repeated for each additional one the intermediate screen 86b, if present.

Finally, the process continues wherein a first end screen 86a is positioned onto the cradle support structure 87 with the bottom edge 97 aligned and positioned along the length of the top surface of the intermediate support beam 145 with the bottom edge 97 of the first end screen 86a abutting the top edge 95 of the intermediate screen 86b. In addition, the top edge 95 is aligned and positioned onto the top surface of the first end support beam 141. Still further, each of the respective widthwise side edges 99 are positioned along the respective arcuate shaped inner surface 115, 117 adjacent to the respective first ends 111a, 113a of the pair of spaced apart arcuate side members 111, 113. Also, the spaced apart brackets 105 of the first end screen 86a are disposed adjacent to the corresponding respective inward side surface with the openings 107 of the brackets 105 aligned with the openings 131, 133 of a respective one of the arcuate side members 111, 113 at the respective first ends 111a, 113a. A block 161 is positioned such that its opening is aligned with the respective pair of aligned openings and a fastener 109 is inserted through the aligned openings to secure one of the brackets 105 and one of the blocks 161 to secure the first end screen 86a to the arcuate side member 111. Similarly, another block 161 is positioned such that its opening is aligned with the respective pair of aligned openings and a fastener 109 is inserted through the aligned openings to secure the other one of the brackets 105 and another one of the blocks 161 to secure the first end screen 86a to the arcuate side member 113.

Referring back to FIGS. 2-10, as mentioned, the housing 84 is also configured to include features for assisting in the removal and insertion of the screen cradle assembly 85 between uses and for retaining the screen cradle assembly 85 in place in the reducing chamber 40 during operation. In particular, the first guide 180, which can be the wear plate, is mounted within the housing 84. If it is in the form of a wear plate, then the first guide 180 can be secured onto an inward facing surface 182, 184 of each of the opposing vertically extending sides 186, 188 of the housing 84 that partially defines the reducing chamber 40. In fact, there may be two first guides 180, one on each side of the housing 84. The rearward portion of the vertically extending sides 186, 188 are connected to each other through the rear barrier 90, which extends transverse to each of the vertically extending sides 186, 188 of the housing 84.

The first guides 180 each include an arcuate outer guide surface 190, 192, with the curvature of the arcuate outer guide surfaces 190, 192 complimentary to the curvature of the screen cradle assembly 85 and the cradle arms 111, 113, which in the preferred embodiment means it is complementary to the curvature of the inner arcuate shaped inner surface 115, 117 of the arcuate side members 111, 113. As will be discussed further below, the complimentary nature of the arcuate outer guide surfaces 190, 192 and the inner arcuate shaped inner surface 115, 117 are used to guide the screen cradle assembly 85 during the installation and de-installation within the reducing chamber 40. Also, the continuous engagement between the arcuate outer guide surfaces 190, 192 and the inner arcuate shaped inner surface 115, 117 serves as one wedge point to maintain the positioning of the screen cradle assembly 85 during use.

As mentioned above, the second guides 220 are secured or integrated to the housing 84 and can be in the form of a plate. As shown, the second guides 220 are an elongated plate that extends at an angle relative to the rotor 48 and are welded to the sides 186, 188 of the housing 84. The outward projections 217, 219 of the cradle support structure 87 extend toward the second guides 220. The second guides 220, along with the first guides 180, assist in orientating the screen cradle assembly 85 during insertion and withdrawal of the screen cradle assembly 85 into and out of the housing 84.

As noted above, the reducing chamber 40 also includes the stop 210, or the pair of stops 210, attached to one or both of the opposing vertically extending sides 186, 188 of the housing 84 and extending transversely to the vertically extending sides 186, 188 within the reducing chamber 40. In certain embodiments, the pin 210 is utilized, which is attached to at least one, or both, of the vertically extending sides 186, 188. As an example, a pair of pins 210 can be utilized, with one of the pair of pins 210 attached to and extending transversely inward within the reducing chamber 40 from one of the vertically extending sides 186 and the other one of the pins 210 attached to and extending transversely inward within the reducing chamber 40 from the opposing one of the vertically extending sides 188, with the length of the pin 210 preferably being parallel and more preferably collinear with the length of the other pin 210.

As noted above, the cover 89 of the housing 84 can be positioned between an open position and a closed position. In the open position, the screen cradle assembly 85 (with each of the screens 86, 86a, 86b, 86c fully assembled to the cradle support structure 87 as described above) can be installed within the reducing chamber 40 according to the following procedure.

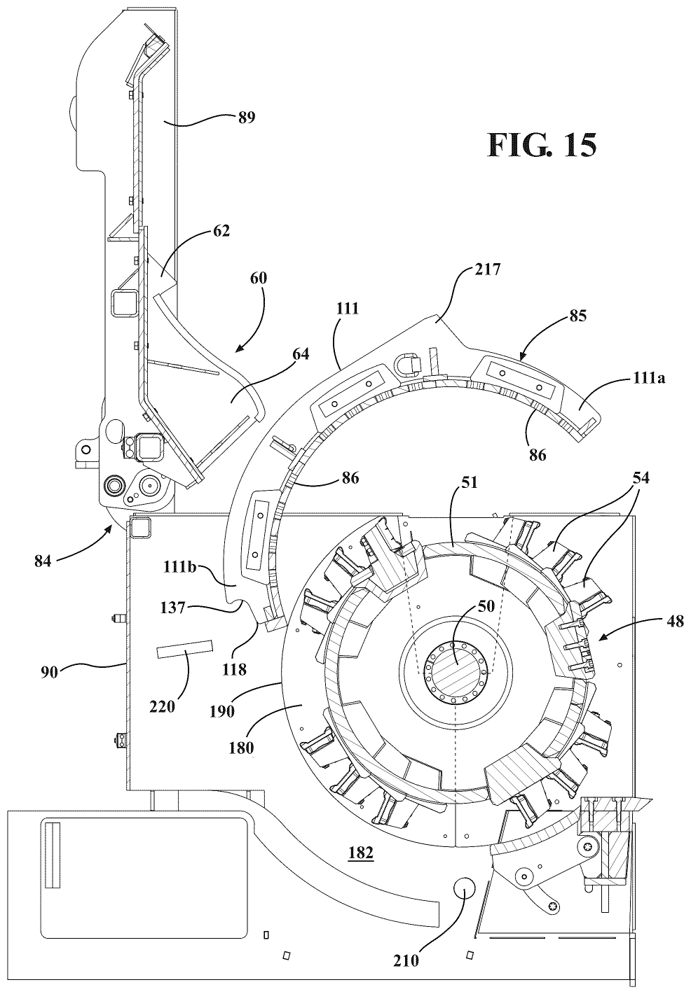

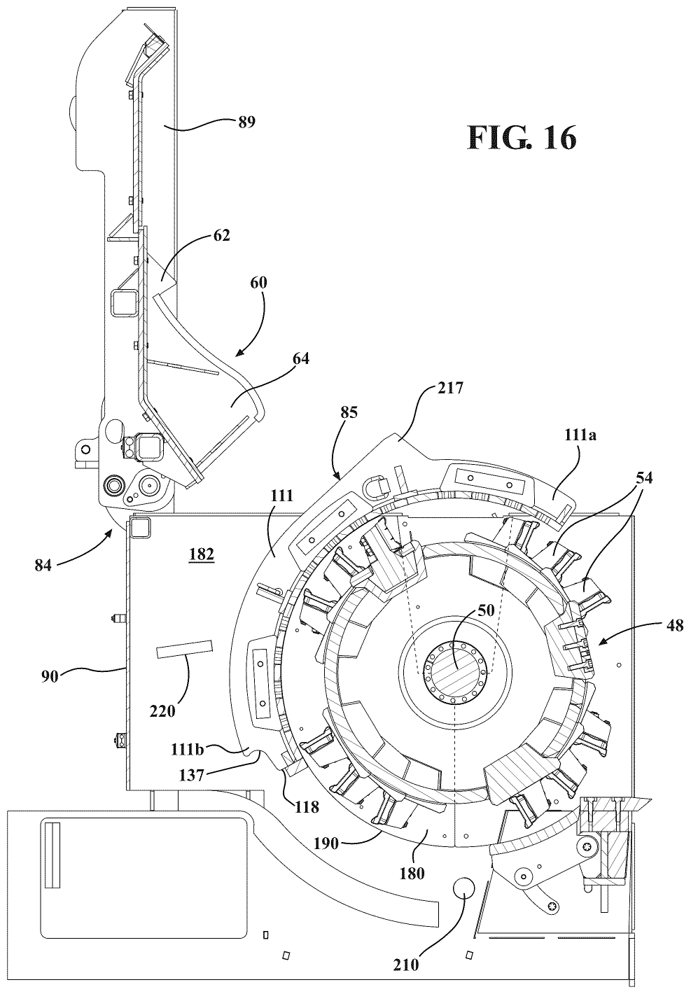

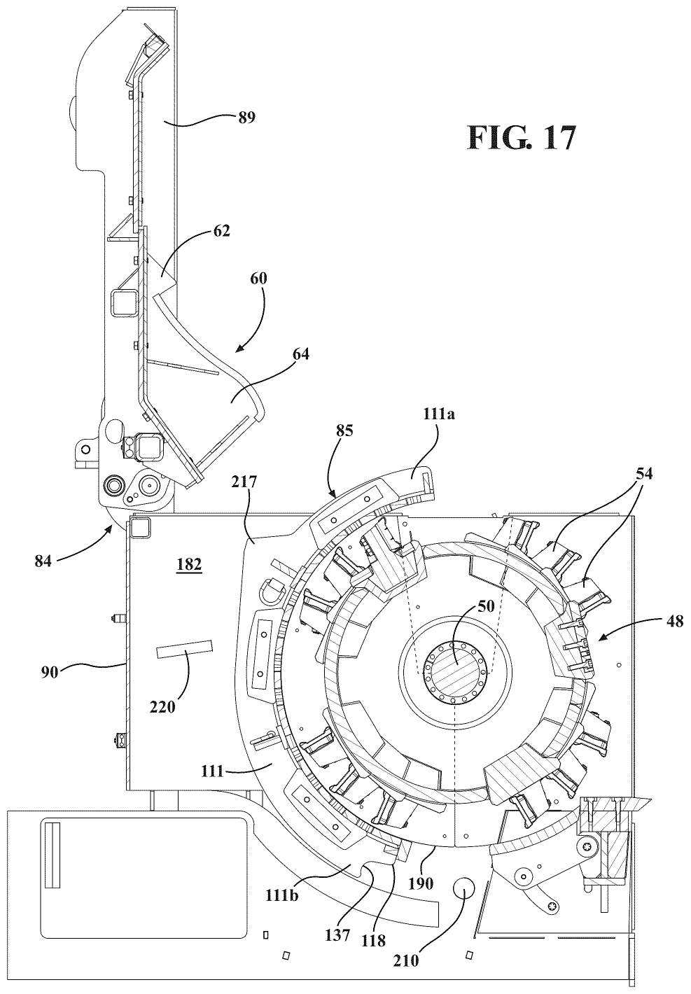

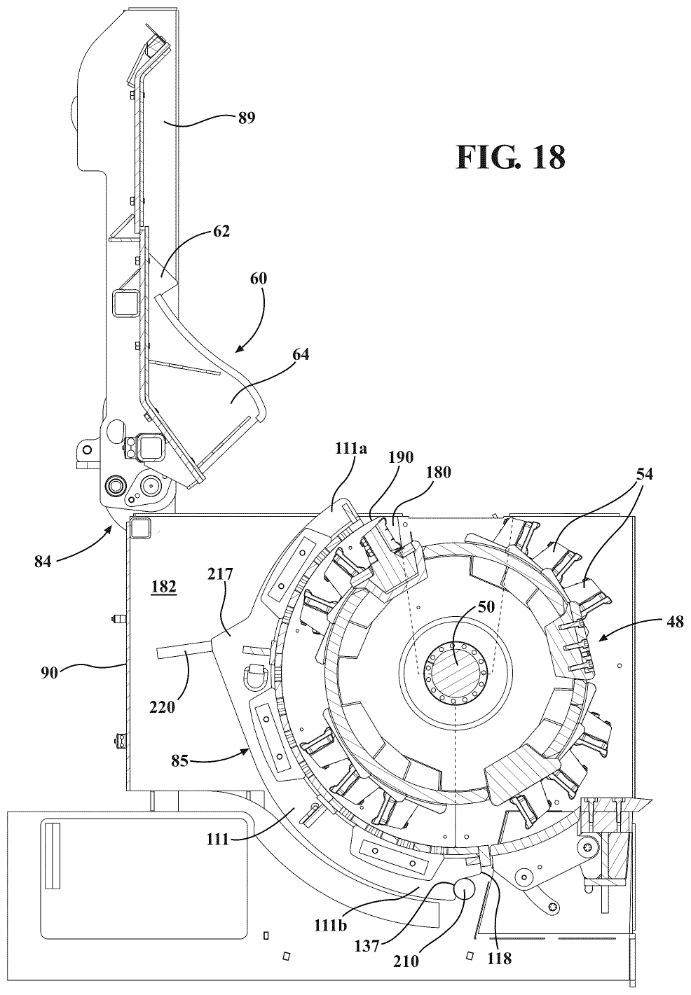

With reference to FIGS. 15-18, the method of installing the at least one screen 86 into the material processing machine 10 is discussed and illustrated. Prior to insertion, the at least one screen 86 is mounted to the cradle support structure 87 of the screen cradle assembly 85. The screen cradle assembly 85 is then introduced within the housing 84. The screen cradle assembly 85 is rotated about the rotor 48 until a second end 111b, 113b of the cradle support structure 87 seats against the stop 210. The retainer 60 is then engaged to the first end 111a, 113a of the cradle support structure 87 to secure the cradle support structure 87 against the stop 210. As mentioned above, the retainer 60 is preferably mounted to the cover 89. As such, the step of engaging the retainer 60 is further defined as pivoting the cover 89 to a closed position. Preferably, the cover 89 is pivoted or moved to the opened position prior to the step of introducing the screen cradle assembly 85. The step of rotating the screen cradle assembly 85 is further defined as abutting the cradle support structure 87 to the first guide 180 and moving the cradle support structure 87 along the first guide 180 when installing within or removing from the housing 84. Further, the step of rotating the screen cradle assembly 85 is further defined as rotating the screen cradle assembly 85 around the rotor 48 in a first rotational direction toward the stop 210 until such time wherein the outward projection 217, 219 engages with the second guide 220 and until the second end 111b, 113b is seated against the stop 210 while the outward projection 217, 219 remains engaged with the second guide 220.

The screen cradle assembly 85 can be introduced within the reducing chamber 40 by introducing the respective second ends 111b, 113b of the spaced apart arcuate side members 111, 113 in the gap between the cover 89 and a front barrier such that inner arcuate shaped inner surface 115, 117 of the arcuate side members 111, 113 are positioned adjacent to the respective arcuate outer guide surface 190, 192 of the first guide 180. Preferably, for safety, a hook or chain is attached to the respective first ends 111a, 113a of the pair of spaced apart arcuate side members 111, 113 of the screen cradle assembly 85 to assist an operator in positioning and moving the screen assembly.

The screen cradle assembly 85 is then lowered toward the stop 210 or stops 210 in a manner such that the second ends 111b, 113b of the spaced apart arcuate side members 111, 113 move in an arcuate manner corresponding to the arc of the arcuate outer guide surface 190, 192 of the first guide 180 wherein the inner arcuate shaped inner surface 115, 117 of the arcuate side members 111, 113 remains in contact (i.e., remains engaged) with the respective arcuate outer guide surface 190, 192 of the first guide 180. This lowering, arcuate movement continues until the lower surface 118, 119 at the respective second end 111b, 113b of each of the pair of spaced apart arcuate side members or cradle arms 111, 113 is seated against a stop 210 or against a respective one of a pair of stops 210. In certain embodiments, the movement continues until the respective notch 137, 139 defined by the lower surface 118, 119 at the second end 111b, 113b of each of the pair of spaced apart arcuate side members or cradle arms 111, 113 is seated against the stop 210 or a respective one of the pair of stops 210 in the assembled state.

As noted above, during the rotation of the screen cradle assembly 85 towards the stop 210 during installation, the outward projections 217, 219 of the side member 111, 113, are brought into contact with the respective second guide 220. The contact between the outward projections 217, 219 and the second guide 220 assists in maintaining the cradle assembly 85 in proper rotational alignment so that the notches 137, 139 are aligned with the stop 210 and properly seated onto the stop 210.

Finally, the hook or chain is removed from the first end 111a, 113a of the pair of spaced apart arcuate side members or cradle arms 111, 113 of the screen cradle assembly 85, and the cover 89 is pivoted from the open position to the closed position. In the closed position, the hooked portion 62 is hooked around the first end 111a, 113a of each of the pair of spaced apart arcuate side members or cradle arms 111, 113 of screen cradle assembly 85 and optionally around the first end support beam 141 to retain the screen cradle assembly 85 with the inner arcuate shaped inner surface 115, 117 of the arcuate side members 111, 113 in contact (i.e., pressing engagement) with the respective arcuate outer guide surface 190, 192 of the first guide 180 and with the lower surface 118, 119 at the respective second end 111b, 113b of each of the pair of spaced apart arcuate side members 111, 113 is seated against the stop 210 or the respective one stop 210 of the pair of stops 210. More in particular, the hooked portion 62 is hooked around the first end 111a, 113a of each of the pair of spaced apart arcuate side members 111, 113 and optionally also around the first end support beam 141 of the screen cradle assembly 85 to press the screen cradle assembly 85 against the respective arcuate outer guide surface 190, 192 of the first guide 180.

Accordingly, in the assembled position with the cover 89 closed, the screen cradle assembly 85 is wedged between the cover 89 of the housing 84, the stop 210, and the first guide 180 with three distinct points of engaging contact with the forces created by this engaging contact on the screen cradle assembly 85 being in different directions such that together these engaging contacts and forces prevent the screen cradle assembly 85 from moving within the reducing chamber 40 during operation. The second guide 220 can provide a fourth point of contact. The first point of engaging contact is between the retainer 60 on the cover 89 and the first end 111a, 113a of each of the pair of spaced apart arcuate side members 111, 113 and optionally also with the first end support beam 141. In the preferred embodiment, the retainer 60 includes the hooked portion 62 and brace portion 64 such that the first point (or points) of engaging contact are between the hooked 62 and brace 64 portions and the arcuate side members 111, 113 and/or the first end support beam 141. The second point of engaging contact is between the inner arcuate shaped inner surface 115, 117 of the arcuate side members 111, 113, while the third point of contact is between the lower surface 118, 119 (and in particular the respective notch 137, 139) at the respective second end 111b, 113b of each of the pair of spaced apart arcuate side members 111, 113 and the respective stop 210 or stops 210. The fourth point of contact is between the outward projection 217, 219 and the second guide 220.

To remove the screen cradle assembly 85 from the reducing chamber 40, the opposite procedure is initiated. In particular, once the material processing machine 10 is put into an inoperable state, the cover 89 is pivoted from the closed position to the open position, wherein the retainer 60 is unhooked from around the screen cradle assembly 85. The hook or chain is attached to the first ends 111a, 113a of the pair of spaced apart arcuate side members 111, 113 of the screen cradle assembly 85 to assist an operator removing the screen cradle assembly 85.

The screen cradle assembly 85 is lifted upward away from the stop 210 or stops 210 in a manner such that the second ends 111b, 113b of the spaced apart arcuate side members 111, 113 moves in an arcuate manner corresponding to the arc of the arcuate outer guide surface 190, 192 of the first guide 180 wherein the inner arcuate shaped inner surface 115, 117 of the arcuate side members 111, 113 remains in contact with the respective arcuate outer guide surface 190, 192 of the first guide 180. The initial movement unseats the lower surface 118, 119 at the respective second end 111b, 113b of each of the pair of spaced apart arcuate side members 111, 113 from against a stop 210 or against the respective one the pair of stops 210. The movement continues until the screen cradle assembly 85 can be removed from the reducing chamber 40 through the gap between the cover 89 and the front barrier.

Once removed, one or more of the screens 86, 86a, 86b, 86c can be replaced with different screens 86, 86a, 86b, 86c having the same or different sized apertures 101 defining openings 103 and the screen cradle assembly 85 reinstalled within the reducing chamber 40 by the same method described above for subsequent operation.

Reducing operations of the material processing machine 10 will now be discussed. Unreduced material is loaded onto the feed conveyor of the infeed system 12 directing the material towards the reducing system 14. The unreduced material may be substantially non-uniform at this point; i.e., the unreduced material comprises material of different types, sizes, shapes, etc. For example, the unreduced material may comprise tree stumps, vegetation, branches, salvaged wood, leaves, dirt, and the like.

The reducing system 14 reduces the material within the reducing chamber 40. The partially reduced material is discharged through the screens 86 of the screen cradle assembly 85 and removed from the reducing chamber 40 and collected through means commonly known in the art. The partially reduced material generally comprises a uniform type and size; e.g., pieces of wood all comprising a size smaller than the openings of the fixed screen.

Several embodiments have been discussed in the foregoing description. However, the embodiments discussed herein are not intended to be exhaustive or limit the disclosure to any particular form. The terminology which has been used is intended to be in the nature of words of description rather than of limitation. Many modifications and variations are possible in light of the above teachings and the disclosure may be practiced otherwise than as specifically described.

What is claimed is:

1. A material processing machine comprising:
an infeed system;
a discharge system;
a material reducing system mounted between said infeed system and said discharge system, comprising:
a housing,
a rotor having a shaft rotatably mounted to said housing and a drum defining an outer surface,
a plurality of processing tool assemblies coupled to and extending outwardly from said outer surface of said drum,
a stop coupled to said housing, and
a removable screen cradle assembly partially surrounding said rotor with said screen cradle assembly comprising:
a cradle support structure having first and second ends with said second end seated against said stop when in an assembled state, and
at least one screen mounted to said cradle support structure; and
a retainer coupled to said housing to engage said first end of said cradle support structure to secure said cradle support structure against said stop.

2. The material processing machine of claim 1, wherein said housing includes a cover pivotable between an opened position and a closed position with said retainer mounted to said cover.

3. The material processing machine of claim 1, wherein said retainer comprises at least one hooked portion engaging said first end of said cradle support structure to secure said cradle support structure against said stop.

4. The material processing machine of claim 3, wherein said cradle support structure includes arcuate cradle arms and wherein said retainer also includes a brace portion adjacent said hooked portion with said brace portion engaging said cradle arms.

5. The material processing machine of claim 1, further including a first guide mounted to said housing and second guide mounted to said housing spaced from said first guide, and wherein said screen cradle assembly is exclusively held into position by said stop, said retainer, said first guide, and said second guide.

6. The material processing machine of claim 1, wherein said retainer applies a first force against said first end of said cradle support structure and said stop applies a second reactive force against said second end of said cradle support structure to radially fix said screen cradle assembly within said housing.

7. The material processing machine of claim 1, wherein said cradle support structure comprises:
arcuate cradle arms connected together by support beams with one of said cradle arms and said support beams further defining said first end and said second end;
further including a notch formed in said second end with said notch seated against said stop; and
said at least one screen mounted to said cradle arms.

8. The material processing machine of claim 1, wherein said stop is further defined as a pin mounted to said housing.

9. The material processing machine of claim 1, further comprising a first guide secured to said housing with said cradle support structure abutting said first guide and moving along said first guide when installed within or removed from said housing.

10. The material processing machine of claim 9 further comprising a second guide secured to said housing with said second guide spaced from said first guide, and wherein said cradle support structure includes an outward projection with said outward projection engaging said second guide when said cradle support structure is in said assembled state.

11. The material processing machine of claim 1, wherein said cradle support structure includes spaced apart arcuate cradle arms and wherein each one of said at least one screen includes a pair of spaced apart brackets with said brackets abutting corresponding cradle arms to facilitate mounting of said screen to said cradle support structure.

12. The material processing machine of claim 1, wherein said at least one screen comprises a plurality of screens each mounted to said cradle support structure.

13. A removable screen cradle assembly for use in a reducing chamber of a material processing machine, the material processing machine including an infeed system, a discharge system and a material reducing system mounted between said infeed system and said discharge system, with the material processing machine including a housing, a rotor having a shaft rotatably mounted to the housing and a drum defining an outer surface, a plurality of processing tool assemblies coupled to and extending outwardly from said outer surface of said drum, a stop coupled to said housing, and a retainer mounted to said housing, said removable screen cradle assembly partially surrounding said rotor and comprising:
a cradle support structure having first and second ends with said second end configured to be seated against the stop when the material processing machine is in an assembled state, and
at least one screen mounted to said cradle support structure.

14. The removable screen cradle assembly of claim 13, wherein said cradle support structure comprises:
arcuate cradle arms connected together by support beams with one of said arcuate cradle arms and said support beams further defining said first end and said second end;
further including a notch formed in said second end and configured for seating against the stop; and
said at least one screen mounted to said cradle arms.

15. The removable screen cradle assembly of claim 13, wherein said cradle support structure includes an outward projection configured for engagement with a guide of the housing.

16. The removable screen cradle assembly of claim 13, wherein said cradle support structure includes arcuate cradle arms and wherein each one of said at least one screen includes a pair of spaced apart brackets with said brackets abutting corresponding cradle arms to facilitate mounting of said screen to said cradle support structure.

17. The removable screen cradle assembly of claim 13, wherein said at least one screen comprises a plurality of screens each mounted to said cradle support structure.

18. The removable screen cradle assembly of claim 13, wherein said cradle support structure comprises arcuate cradle arms further defining said first end and said second end, and further comprising:
a first end support beam connecting said first end of each of said arcuate cradle arms, and
a second end support beam connecting said second end of each of said arcuate cradle arms, and
at least one intermediate support beam connecting each of said arcuate cradle arms between said first and second ends.

19. The removable screen cradle assembly of claim 18, wherein said at least one screen includes a first end screen, a second end screen and at least one intermediate screen.

20. A method of installing at least one screen into a material processing machine, with the material processing machine including a housing, a rotor having a shaft mounted to the housing and a drum defining an outer surface, a plurality of processing tool assemblies coupled to and extending outwardly from said outer surface of said drum, a stop coupled to said housing, a retainer coupled to said housing, and a screen cradle assembly having a cradle support structure, said method comprising the steps of:
mounting the at least one screen to the cradle support structure of the screen cradle assembly;
introducing the screen cradle assembly within the housing;
rotating the screen cradle assembly about the rotor until a second end of the cradle support structure seats against the stop; and
engaging the retainer to the first end of the cradle support structure to secure the cradle support structure against the stop.

21. The method of claim 20, wherein the material processing machine includes a cover pivotable between an opened position and a closed position with the retainer mounted to the cover, and wherein the step of engaging the retainer is further defined as pivoting the cover to a closed position.

22. The method of claim 21, further including the step of pivoting the cover to the opened position prior to the step of introducing the screen cradle assembly.

23. The method of claim 20, further including a first guide secured to the housing and wherein the step of rotating the screen cradle assembly is further defined as abutting the cradle support structure to the first guide and moving the cradle support structure along the first guide when installing within or removing from the housing.

24. The method of claim 20, further including a second guide mounted to the housing and wherein the cradle support structure includes an outward projection, and wherein said step of rotating the screen cradle assembly is further defined as:
rotating the screen cradle assembly around the rotor in a first rotational direction towards the stop until such time wherein the outward projection engages with the second guide and until the second end is seated against the stop while the outer projection remains engaged with the second guide.
